(19) United States
(12) Patent Application Publication
(10) Pub. No.: US 2010/0058684 A1
(43) Pub. Date: Mar. 11, 2010

(54) VENTILATOR

(75) Inventor: Torbjorn Blomqvist, Lammhult (SE)

Correspondence Address: DAVIS & BUJOLD, P.L.L.C., 112 PLEASANT STREET, CONCORD, NH, 03301, US

(73) Assignee: STEELFORM SCANDINAVIA AB, Lammhult (SE)

(21) Appl. No.: 12/532,876

(22) PCT Filed: Feb. 7, 2008
(86) PCT No.: PCT/SE08/00104

§ 371 Date: Sep. 24, 2009

(30) Foreign Application Priority Data
Apr. 11, 2007 (SE) 0700871-7

(51) Int. Cl. E06B 7/02

(52) U.S. Cl. 52/209

(57) ABSTRACT

A valve (1), for controlling air flow to a premise, is primarily mounted on or in a window frame (2). The valve (1) comprises a profile (4), which controls the admission of air. The profile (4) is mounted between two corner portions (3), which retain the profile (4) and which also fasten the profile (4) in its closed position as well as its open position. The valve (1) is opened and closed by applying a force, such as a pressure, on the front of the profile (4), while closing being done by letting the corner portions (3) catch the profile (4). A draft preventer (5), on the inner side of the profile (4), guarantees that the valve (1) is sealed and that opening can be done by pressing the profile (4) inward somewhat from its closed position. The profile (4) is detached and initially opened up.

This application is a national stage completion of PCT/SE2008/000104 filed Feb. 7, 2008 which claims priority from Swedish application serial no. 0700871-7 filed Apr. 11, 2007

### FIELD OF THE INVENTION

The present invention relates to a device, designed to regulate and/or control the air flow to premises.

One example of this design is described below. The invention is primarily designed to be used in a combination with a window and its frame. Of course, the invention can be assembled separately on a wall or beside or in connection with a window or with a window-door-combination.

What is entirely new according to the present invention is the construction of the valve, in which the opening-closing-components as well as the air elimination function afford a completely new solution and in which the construction facilitates an outside as well as an inserted mounting, the exterior design and the economy of the total solution also being attractive.

### BACKGROUND OF THE INVENTION

Known devices used for this purpose are impaired by various drawbacks. Valves are known, in which the component, which is designed to admit the air, has an insufficient width or length on the air elimination portion. In these instances the air, which flows through the valve, will flow downwards quite close along the window surface, which means, that the window surface will be cold with the drawbacks, which this entails, at the same time as the air flow is experienced as a cold air flow.

An additional drawback with other known devices is, that they cannot be inserted into the window frame, which implies, that they extend outwards from the plane of the window frame, the result being, that the complete window requires more space, when it is packed and transported from the window manufacturer, at the same time as the risk of damage to the protruding details is increasing.

Also, the known devices often have an old-fashioned design with e.g. dirt collecting portions and various more or less difficult to manage solutions as regards the opening mechanisms.

### SUMMARY OF THE INVENTION

The object of the present invention is to counteract and as far as possible eliminate the above-mentioned problems. Also, one object of the present invention is to develop the state of the art in this technical field in various respects. These objects are attained according to the invention by a device of the type described in the introduction designed in a novel way.

Additional characterizing features and advantages of the present invention are set forth in the following description, reference being made to the enclosed drawings, which show a preferred but not limiting embodiment.

In the present description the invention has been mounted in a window frame, which only is one example of an application of the invention. Also exteriorly seen the described design is just one suitable design. One alternative example is a completely smooth, arched surface without any dirt/dust-collecting portions.

### BRIEF DESCRIPTION OF THE DRAWINGS

In the now depicted and described design of the valve the various figures show:

FIG. 1 an exterior picture of an air valve, mounted on a surface;

FIGS. 2a-2b the design of the air elimination profile;

FIG. 3a a front elevation view of the design of a corner portion;

FIG. 3b a top view of the design of a corner portion;

FIG. 3c a top pictoral view of the design of a corner portion;

FIG. 3d a bottom pictoral view of the design of a corner portion; and

FIGS. 4a-4f illustrate the cooperation between the air elimination profile; and the corner portion.

### DETAILED DESCRIPTION OF THE DRAWINGS

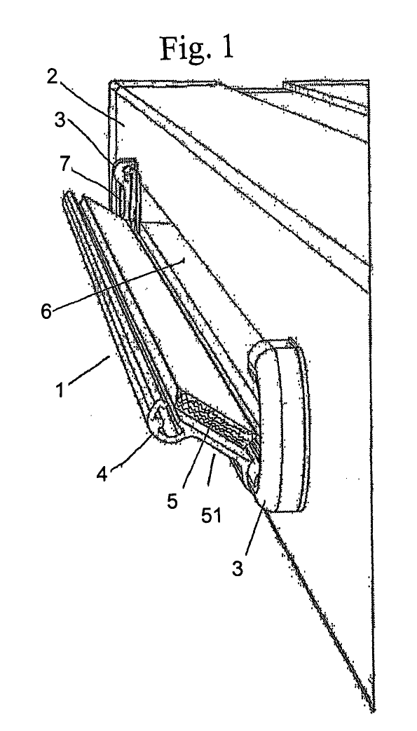

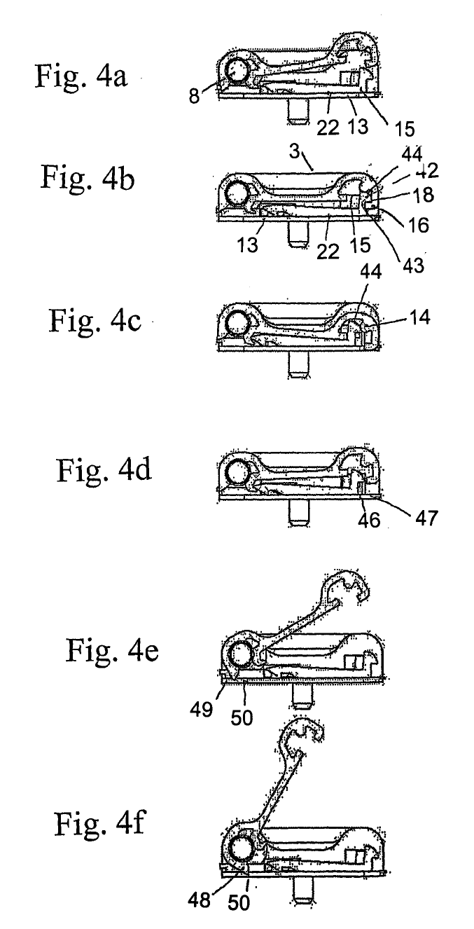

FIG. 1 shows an air flow valve 1 in an exterior mounting on a window frame 2. This air flow valve—called the valve from now on—comprises two corner portions 3 and a profile 4. Profile 4 is at its rear end 24 fastened and articulated between the corner portions. The profile preferably is provided with a draft preventer 5, which is fastened to the interior surface of the profile. The draft preventer can as an alternative be mounted on the window frame and only seal against profile 4 in the closed position of the valve. The draft preventer seals an opening 6 in frame 2. Draft preventer 5 is used partly as a seal, if the valve is closed, since its width and length are somewhat larger than opening 6, and partly as a spring, a force being obtained, which allows an initial opening of valve 1 in the position, in which it is opened up. How the valve is controlled, is described in connection with FIG. 4.

The design of the invention implies, that the complete valve also preferably can be mounted in a lowered condition, completely or partially, into the window frame. This will be possible, since the valve is mounted straight from the front and the manipulation also does not require any accessibility, except that a force must be applied to a front surface 51 on the profile in connection with a closing or an opening of the valve. The design of the valve implies, that also during an inserted mounting the opening of the valve is secured, the same being provided with a built-in spring or spring-like component, which provides an initial opening of the valve, and from which position then a suitable opening position can be chosen.

The entire valve preferably can be partially mounted as a complete product and shipped to a window manufacturer or to a final building place to be installed on the selected place, which does not always have to be a window. The valve preferably is mounted on the window frame by means of a screw 7 in each corner portion. The fastening against the window frame or the like can of course be done according to alternative principles within the scope of the present invention.

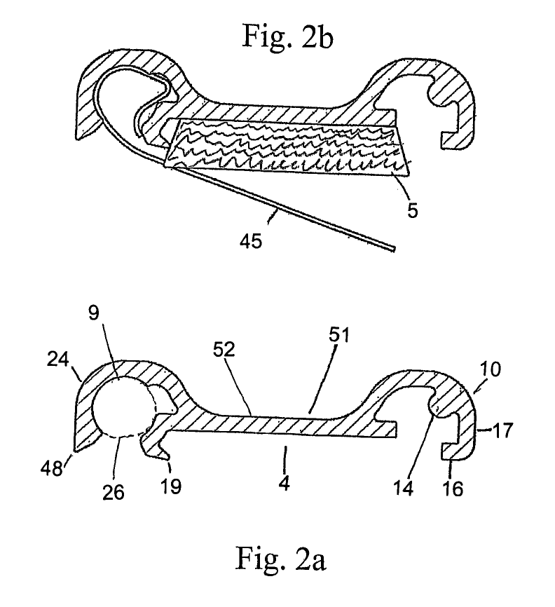

FIGS. 2a, 2b show the design of the profile 4 in sectional views. The profile preferably is an extruded aluminum profile. The exterior shape can of course vary in many respects within the scope of the invention. The main functions of the aluminum profile is to constitute a covering surface for the air inlet or opening 6 in the window frame or another surface, to cooperate with corner portions 3 and to be an air flow elimination member.

The profile has a front end 10 and a rear end 24 and between these portions an intermediate portion 52, which preferably is positioned in an imaginary central plane between ends 10 and 24. The dimensions of the profile will be tested and selected in order to guarantee a satisfactory functioning, particularly as regards the torsional strength, and to obtain the function, which renders the valve its specific properties.

FIGS. 2a, 2b show, how the cooperation between the profile and the corner portion takes place—see also FIGS. 4a-4f—a bearing pin 8 in the corner portion being fit into an inscribed circle 26 in a substantially round portion 9 of rear end 24 of the profile. The corner portion is mounted in the two ends of profile 4 and this means, that the corner member is made in one right and one left version. In the other end 10 the profile is designed to be able to cooperate with a bolt 11, which constitutes another part of the corner member. This cooperation is described in detail in connection with FIGS. 4a-4f.

The profile cooperates with corner portion 3 and its various portions, bolt 11, a covering portion 12 and a bottom portion 13. The design of corner portion 3 with alternative immediate solutions of the locking/disengagement of the profile, this being done by means of displaceable pins or spring-loaded clutches, are just design alternatives of the present invention. Corner portion 3 can also be made of two details, possibly just one detail, but it can nevertheless meet the requirements, which are set forth in the present text. The fact that the corner portion e.g. can comprise only two details and that in such a case bolt 11 and bottom portion 13 are made as one detail, is one example of a possible alternative design of the invention.

Front end 10 of the profile is on its inside provided with a portion 14 with a design, which looks like a bun. This portion cooperates with a plate 15, which constitutes a portion of bolt 11, in connection with the opening and the closing of valve 1. Its function is depicted and explained, reference being made to FIGS. 4a-4f.

Front end 10 of the profile also is also provided with a nose 16, which preferably is bent 90 degrees from a front edge 17 on end 10 on the profile and towards rear end 24. This nose 16 is inserted into a plane 18, which is provided on plate 15 and in this way the profile will be locked in a closed position.

The profile is provided at its rear end 24, the mainly round portion 9, with a design, which implies, that a portion of the circumference is split open, a portion of the circumference being provided with a portion, which is turned downwards in relation to round portion 9, this downwardly turned portion being terminated with a point 19, which with about 45 degrees extends towards nose 16. Rear end 24 on the profile can as an alternative be a hole profile with protruding portions, which constitute point 19, which extends forwards, and a point 48 respectively, which extends rearwards/downwards.

The function of point 19 is to disengage the locking of the bolt, which belongs to plate 15, from its locked position against bottom plate 13 and this is done in such a way, that plate 15 is lifted from its locking position, in which the plate has been inserted into bottom plate 13 and a middle portion 20, which extends upwards from the plane of the bottom plate and is positioned between two punchings 21 in bottom plate 13, the midportion in the locking position having been inserted into a groove 39 in the underside of the plate and at a rear end 23 of the plate.

The profile is also provided in its rear end 24 with a point 48, which extends downwards and obliquely backwards and which constitutes a stop lip, which determines the maximum opening angle of the profile in relation to bottom portion 13 of corner portion 3. This is described with reference to FIG. 4f.

FIG. 2b shows draft preventer 5, mounted on the profile, and that also a spring 45 is mounted in the mainly round portion 9 in rear end 24 on the profile. This spring is dimensionally seen chosen in such a way, that it provides a reinforced opening force, when the profile is disengaged from its closed position. Spring 45 is an option, which implies, that the size of the opening increases in relation to the design with only draft preventer 5, when the profile is displaced from its closed position. The opening is secured to a level, which makes it possible to subsequently open it to the final suitable position particularly in cases, when the valve is mounted, inserted into e.g. the window frame. The spring is a construction detail, which preferably always can be applied on the present invention, but no absolute requirement exists.

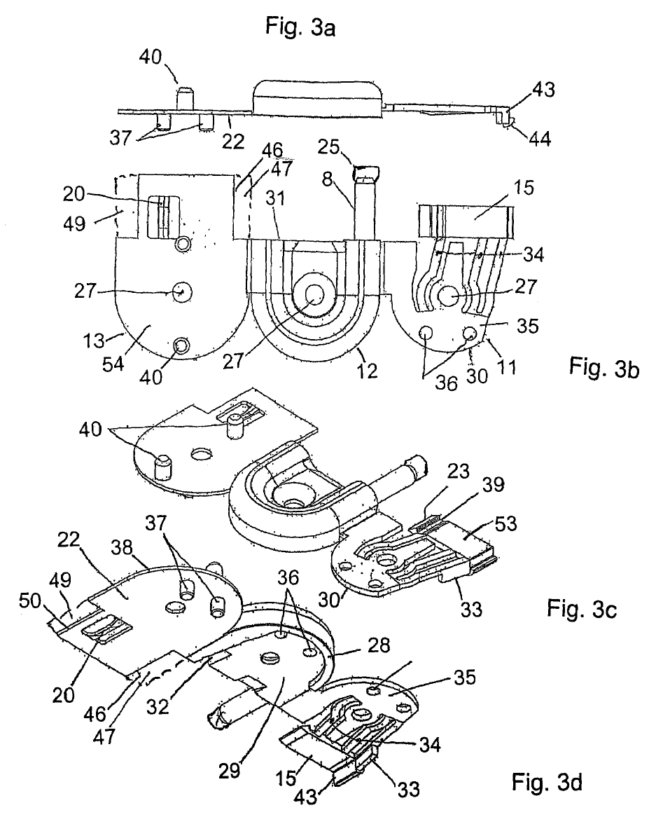

FIGS. 3a-3b show the construction of corner profile 3. It comprises three main components, bolt 11, covering portion 12 and bottom portion 13. The main function of the corner profile is to:

guide and control profile 4;

constitute the fastening of the complete valve on preferably a window frame;

control the two corner portions in such a way, that they are allowed to obtain a secured, suitable mounting direction;

control the profile, when it will be closed; and

detach the profile, when it will be opened up.

In order to obtain a cost-efficient complete product the details of the corner portion will be made of a suitable material, preferably a plastic material, e.g. a polyacetale or a polypropene quality. A material combination with an Al-alloy or a similar metal alloy as a supplement is also an alternative.

Dimensionally seen, corner profile 3 is coordinated with profile 4. The total width of the corner profile as well as the height will be chosen in such a way, that the total impression of complete valve 1 will be aesthetically attractive. The width is important for the air flow function of the valve. It must be chosen in such a way, that the air, which flows inwards through the valve, in a guaranteed way obtains a flow direction, which results in, that the air flow is not cooled by an adjacent cold surface—a glass surface—but flows outwards through opening 6 and through the premises with a minimal influence, caused by the cold surface. With such a throw length of the air flow, annoying cold experiences could be avoided, which otherwise will be a problem with existing constructions.

The corner profile controls the profile.

This is done by providing covering portion 12 of the profile with a bearing pin 8, which, regarding its diameter, is coordinated with the mainly round portion 9 and a circle 26 in the profile, inscribed therein. In order to obtain the right friction between pin 8 and the profile pin 8 is provided with an outer end 25, the diameter of which is somewhat larger than the diameter of pin 8 and also somewhat larger than the diameter of the inscribed circle 26 in the mainly round portion 9. Outer end 25 has a thickness of material of between 0.1 and 1.0 mm and preferably 0.2-0.3 mm. The length of this part is about 2-10 mm. The dimensions of these cooperating parts have been examined, the result being, that profile 4 has a friction against the corner portion, which implies, that the profile, when nose 16 on the profile is opened up/disengaged, is opened up/turned a few degrees and then stops. The valve is then manually opened up to a suitable position. Thanks to a built-in friction the profile stops in the opened up suitable position, until the position of the profile manually is changed again.

The corner profile fixes the valve.

The valve is fastened at window frame 2 above opening 6, preferably by means of screw 7, which is tightened through a hole 27, which exists in bolt 11, covering portion 12 as well as bottom portion 13. In the mounting position these holes are positioned along the same center line.

Controls the alignment of the corner portion.

In the mounting position the three main portions, bolt 11, covering portion 12 and bottom portion 13, are assembled into one unit. They are mutually guided, their mounting position being secured. Thus, covering portion 12 comprises a rear half circle-shaped wall 28, which surrounds a recessed surface 29. Of course, as an alternative, cooperating portions 11, 12 and 13 may have another exterior shape than the one described above, and nevertheless the present invention may comprise these portions.

Recess 29 has the same depth as the thickness of a base portion 35 of bolt 11. On this recessed surface bolt 11 is positioned, which has a cooperating shaped rear part 30, and the bolt also has a plate 15, which projects outwards in front of and in parallel with a front edge 31 on covering portion 12. In order to additionally control bolt 11 there is a recess 32 in the front edge on the recessed surface 29 on covering portion and in this recess a rectangular pin 33 on bolt 11 is inserted and controls and stabilizes the front part of the bolt and makes it torsion resistant. The bolt preferably has three legs 34, which connect base portion 35 with plate 15. The material thickness of these legs is slightly thinner than base portion 35 in order to give the plate a certain flexibility in the longitudinal direction as well as in the elevational direction in order to in this way improve the locking function between a mid portion 20 of bottom portion 13 and a groove 39, located on an underside 53 and adjacent a rear end 23 on plate 15, groove 39 being designed with a perpendicular edge in its rear portion, whereas the groove in the front edge preferably is designed with a certain inclination up to underside 53.

There are two holes 36 in base portion 35, which cooperate with the corresponding two control pins 37 on bottom portion 13.

Bolt 11 is positioned on the recessed surface 29 on covering portion 12 and subsequently bottom portion 13 is placed on top of bolt 11. The bottom portion is provided with a rear radial portion 38, which has the same radius or shape as wall 28 on covering portion 12, and, when the bottom portion is placed above bolt 11, which is placed in the recessed portion, surface 29 on the covering portion, these three portions, the bolt, the covering portion and the bottom portion, are connected to each other, when control pins 37 on the bottom portion extend through holes 36 in the bolt and into corresponding recessed holes in the covering portion, a certain force fit being carried out.

The corner portion is in this way assembled to become a unit.

In order to control the direction of the corner portion, in order to give the two corner portions a common center line through bearing pins 8, bottom portion 13 is provided with two guide pins 40. These pins are inserted into pre-bored holes in the surface, on which the valve will be mounted. Control pins 40 unload bearing pins 8, so that these do not have to receive the deviations due to a wrong mounting. Thanks to guide pins 40 it is guaranteed, that bearing pins 8 will end up along the same mounting/center line.

Corner portion 3 will also:
control the profile, when it will be closed; and
disengage the profile from the corner portion, when the valve will be opened up.

How a cooperation between profile 4 and corner portion 3 will function in those cases, is illustrated and described in detail in the description, which refers to FIG. 4 below.

The valve always has a corner portion provided with the functions, which allow a locking and a disengagement of the profile. It is always possible to provide the two corner portions with these functions, but there is on the other hand no requirement, that the two corner portions have these functions. One portion preferably can be designed in such a way, that plate 15 on the bolt in this case does not have any locking function in relation to profile 4 or alternatively that bolt 11 can be designed without plate 15. Other alternative designs are possible in a natural way within the scope of the present invention.

FIGS. 4a-4f show a few mutual positions between profile 4 and corner portion 3.

FIG. 4a shows a position, in which profile 4 almost is closed. In this position no part of the corner portion is influenced by the profile. Bolt 11 and its plate 15 are placed in this position not influenced at all in direct contact with an upper side 22 on bottom portion 13.

FIG. 4b shows the position, in which the profile with its nose 16 has been inserted into plane 18 on plate 15.

When the profile with its nose 16 during the closing moment initially downwards reaches corner portion 3, nose 16 to start with hits a nose 42, nose 42 constituting a rectangular portion 43, which preferably has the same width and material thickness as plate 15, portion 43 extending at right angles to and upwards from plate 15 and this portion being provided with a mounted portion, an oblique plane 44, which extends an additional small distance forwards in the direction of plate 15 and in a curve downwards towards bottom portion 13. An oblique plane ends with a plane 18, which runs in parallel with the longitudinal direction of the plate and inwards/backwards towards the plate. The depth of this plane is adjusted to nose 16 on the profile and the distance from plane 18 upwards towards oblique plane 44 and its upper portion is also chosen in such a way, that inner portion 14 of the profile in this position almost is touching said oblique plane 44. The distance from an upper side 22 on bottom portion 13 and upwards towards plane 18 is chosen in such a way, that there is a play between the profile and the lower edge on nose 16, which preferably is somewhat larger than the material thickness of nose 16. The portion, which is called oblique plane 44, can be designed with an alternative shape, e.g. a straight oblique plane, but these alternative designs are just detail solutions within the scope of the present invention.

There is also a recess 47 in a front edge 46 on bottom portion 13, which implies, that the play between nose 16 and underlying portions will be larger.

When nose 16 has glided along oblique plane 44, the nose has forced plate 15 backwards. The plate is able to move in a horizontal direction, because legs 34, which connect the plate with base portion 35 of the bolt, have a smaller material thickness than the base portion of the bolt, namely the portion, which is fastened between recessed surface 29 on covering portion 12 and upper side 22 on bottom portion 13, and in this way no portion of the length of legs 34 is clamped between bottom portion 13 and covering portion 12, when corner portion 3 is mounted to become a unit and in this way bolt 11 has obtained a flexibility, which depends on the chosen material thickness of legs 34.

When nose 16 on the profile has left oblique plane 44, the plate will resume its rest position, i.e. the plate will spring back, up to the position, which implies, that nose 16 is caught below plane 18.

FIG. 4c shows, that, when the valve is closed, it will be opened up by applying a force downwards/inwards to front surface 51 on the profile, preferably close to the corner profile. The profile is then pressed downwards/inwards a further distance towards window frame 2. This will be possible, because the profile in its closed rest position has not been lowered completely along upper side 22 of the bottom portion, i.e. the profile is positioned in its closed position with a play in relation to bottom portion 13 and its upper side 22. Thus, when the profile is pressed downwards towards the bottom portion or rather downwards towards frame 2, since bottom portion 13 is provided with recess 47, which extends downwards towards front edge 46, recess 47 extending inwards towards and along front edge 31 on covering portion 12, the inner portion or bun 14 of front end 10 on the profile displacing plate 15 on bolt 11 a somewhat further distance backwards, than what happened, when nose 16 initially glided along oblique plane 44. When now the plate has been forced backwards an additional distance, the plate will end up so far backwards, that groove 39 in the underside of the plate will be inserted into mid portion 20 of bottom portion 13. This insertion is obtained, because the mid portion is somewhat elevated in relation to upper side 22 and also mid portion 20 is inclined, its rear end, its rear longitudinal side, being placed at a higher level than its front longitudinal side. This will result in, that groove 39 and also the plate clings to this oblique mid portion, as soon as profile 4 starts moving upwards, when the profile starts opening up from its downwardly pressed position. When the profile starts moving towards an open position, bun 14 will no longer be pressed against oblique plane 44 and then the force, which has pushed plate 15 backwards, will cease. The plate is then striving to resume its rest position, which however is prevented due to the insertion between groove 39 and its insertion in mid portion 20.

FIG. 4d

When profile 4 was pressed downwards according to FIG. 4c, the locking in its front edge 17 had ceased. When now the exterior force, which was pressing the profile downwards, is removed, the profile will open up, since the inner spring force, which primarily is obtained from draft preventer 5, now is striving to open up the same. When it is opened up, preferably 5-15 degrees, point 19 on the rear portion of the profile will lift plate 15, the result being, that the insertion of the plate in mid portion 20 in bottom plate 13 ceases. When the opening up continues, point 19 on the profile will “pass” rear end 23 on plate 15 and in this way the plate is completely free and may resume its rest position. The opening of the profile to a suitable position—see FIG. 4e—is done manually. The profile remains in this position thanks to the chosen friction, which has been obtained between bearing pin 8 and the mainly round portion 9 of the profile.

FIG. 4f shows the maximum opening, which the profile can obtain in relation to the corner portion. The maximum opening depends on rear point 48 on rear end 24 on the profile. When the profile has been turned upwards, this point reaching a recess 49, made in bottom portion 13 and having a rear edge 50, in front of recess 47, this stop allows the maximum opening up of the profile.

1-17. (canceled)

18. A device for regulating and controlling air flow to a premise, the device being mounted either in or on a window frame (2), the device comprising an air flow valve (1) for regulating and controlling the air flow, a profile (4), which at its rear edge with articulation being fastened between two corner portions (3), which are mounted on the window frame (2), the profile (4) being provided with a draft preventer (5), on its inner surface, which is combinable with a spring (45), the draft preventer (5) having a width and a length which is somewhat larger than an opening (6) in the frame (2), the profile (4), in a closed position, being fastened by the corner portion (3), the valve (1) being opened and closed by a force, a pressure applied on a front surface (51) of the profile (4), the corner portion (3), at the same time as the valve (1) is closed, locks the profile in a closed position, and the valve can be reopened by reapplying a force to the front surface of the profile, the profile yielding an additional distance downward from the closed position, and the locked position being disengaged and the profile being opened, due to a spring force, which the compressed draft preventer (5) exerts.

19. The device according to claim 18, wherein the complete valve (1) is mounted on top of, or completely or partially inserted within the window frame (2), by mounting the complete valve (1) straight from a front, and this is also applicable when the device is manipulated.

20. The device according to claim 18, wherein the profile (4) cooperates with a covering portion (12) of the corner portion (3) and a bearing pin (8), on the covering portion (12) in a diametrical direction, is coordinated with a substantially round portion (9) and a circle (26), which is inscribed in the round portion, on a rear end (24) on the profile, and the covering portion (12) with the bearing pin (8) is mounted in the two ends of the profile (4), and the profile (4) subsequently is fastened along its longitudinal axis with an articulation fastened to the bearing pin (8).

21. The device according to claim 20, wherein the bearing pin (8) has an outer end (25) which has a diameter slightly larger than the diameter of the bearing pin (8) and also slightly larger than the diameter of the inscribed circle (26) in the substantially round portion (9), the dimensional relations between the outer end (25) and the inscribed circle (26) causes the profile (4) to rub against the corner portion (3) so that the profile remains in either an open or a partially open position.

22. The device according to claim 18, wherein the profile (4) has a front end (10) and a rear end (24) and between the front and rear ends is a mid portion (52) with a front surface (51), which advantageously is positioned in an imaginary center between the front and the rear ends (10, 24), and a distance between the front end and the rear end is such that, when the valve (1) is open and air flows through the valve, a secured flow direction and throw length of incoming air flow is obtained so that the air flow is not cooled by cold surfaces, with an ensuing cooling feeling.

23. The device according to claim 18, wherein the profile (4) has a front end (10) with a front edge (17), which preferably extends at right angles to a longitudinal axis of the profile and away from a front edge (51) on the profile and which terminates downwardly with a nose (16), which is bent 90 degrees from the front edge (17) and towards a rear end (24) of the profile, and an inner portion (14) is in a front end (10) of the profile, a nose (16) is a portion, which retains the profile in relation to the corner portion (3), when the profile is in the closed position, the inner portion (14) facilitates reopening of the profile from the closed position.

24. The device according to claim 18, wherein the profile (4) has a rear end (24) and a substantially round portion (9) so that a portion of the circumference has a downwardly extending part which terminates in a point (19), which extends at an angle of about 45 degrees towards a nose (16), and the point is used to disengage a plate (15) on the corner portion (3) from an insertion in a bottom portion (13) of the corner portion (3).

25. The device according to claim 18, wherein a rear end (24) of the profile has a point (48) which extends obliquely backwards, in relation to a front edge (17), and the point (48) constituting a stop lip which abuts against a bottom portion (13) of the corner portion (3) and consequently determines a maximum opening angle of the profile.

26. The device according claim 18, wherein the draft preventer (5) is mounted on an inner surface of a mid portion (52) of the profile (4), the draft preventer partially functions as a sealing, when the valve (1) is closed, since a width and a length of the draft preventer is larger than the opening (6) in the window frame (2), and partially as a spring which exerts a force which allows the valve to initially open up the same into such a position, that it will be opened up.

27. The device according to claim 18, wherein the profile (4) with its draft preventer (5) has the spring (45), which is mounted in a substantially round portion (9) in a rear end (24) of the profile, and dimensions of the spring (45) are chosen such that the spring is partially contained within outer measures of the profile and partially exerts a reinforced opening force, when the profile is detached from the closed position.

28. The device according to claim 18, wherein the corner portion (3) comprises three main components, a bolt (11), a covering portion (12) and a bottom portion (13), the three components are guided in such a way that their mounting position, in relation to each other, is ensured since the covering portion (12) is provided with a rear half-circle-shaped wall (28), which surrounds a recessed surface (29), on which a base portion (35) of the bolt (11) is placed, the base portion (35) having a thickness essentially equal to a depth of the recessed surface (29), and the bottom portion (13) is positioned on top of the bolt (11), the bottom portion (13) is provided with a rear radial portion (38), which has the same radius or shape as the wall rear half-circle-shaped wall (28) of the covering portion (12), and to fasten the three main components properly in relation to each other the bolt (11), the covering portion (12) and the bottom portion (13) being connected to each other by two control pins (37) on the bottom portion (13), which are pressed through corresponding two holes (36) in the bolt (11) and into corresponding recessed holes in the covering portion (12), such that the corner portion (3) is assembled into a unit.

29. The device according to claim 28, wherein the bolt (11), in addition to the base portion (35), has a plate (15) which extends outwards in front of and in parallel to a front edge (31) on the covering portion (12), the plate (15) has three legs (34) which connect the plate with the base plate, a material of the legs being thinner than a material of the base portion (35) to provide the plate with flexibility such that the plate (15) is displaced, in a longitudinal and a vertical direction, because the base portion (35) of the bolt is jammed into the complete corner portion (3).

30. The device according to claim 29, wherein the plate (15) is provided with a groove (39), which runs across an entire width of the plate and is positioned on an underside (53) and adjacent a rear end (23) of the plate, the groove (39) has a perpendicular edge, on a portion thereof, to allow a mid portion (20) in the bottom plate (13), which is inserted into the groove (39), at the same time, as the profile (4) will be opened up from the closed position in relation to the corner portion (3), when the plate (15) is forced backwards from a normal position.

31. The device according to claim 29, wherein the plate (15) in a front portion has a rectangular portion (43), which extends transversely to and up from a plane of the plate and which preferably has a same width and material thickness as the plate, the rectangular portion being provided with an additional portion, an oblique plane (44), which extends an additional small distance forwards in the longitudinal direction of the plate, in an arch downwards towards the bottom portion (13) and is terminated in a plane (18), which runs parallel to the longitudinal direction of the plate and inwards/rearwards towards the plate, a depth of the plane (18) being adjusted to a nose (16) on the profile (4) and a distance from the plane (18) and up to an upper edge on the oblique plane (44) being chosen such that an inner portion (14) of the profile (4), when the nose (16), which interferes with the plane (18), is in close contact with the oblique plane (44).

32. The device according to claim 18, wherein the valve (1) is closed by pressing the profile (4) either downward or inward towards the corner portion (3), a front edge (17) of the profile with a nose (16) initially abutting against an oblique plane (44) on a plate (15), the plate being displaced backward, at the same time as the profile and the nose (16) glides downward along the oblique plane to arrive at a position below the oblique plane, the plate (15) subsequently is moved forward into a starting position, due to the spring force, which was developed in legs (34) when the plate was pressed backward, when the nose (16) glided across the oblique plane (44), the plane (18), when the plate (15) returns to the starting position, is positioned above the nose (16) and consequently is able to lock the nose so that the valve (1) remains closed.

33. The device according to claim 18, wherein the valve (1) is reopened by applying, in the closed position of the valve, a force against the front surface (51) on the profile (4), the profile and a front edge (17) of the profile are displaced downward, past an upper side (22) of a bottom portion (13), and downward towards a recess (47), the profile (4) and an inner portion (14) of the profile displace the plate (15) backward such that a rear part of the plate, with a groove (39), will pass a mid position (20) of the bottom portion (13); and when the force is removed from the front surface (51), the plate will again spring forward since the inner portion (14) started to ease and move rearward in relation to the plate (15), the groove (39) is caught by the mid portion (20) thereby stopping the plate from moving to the neutral position, the nose (16), in this way, is not stopped by the plane (18) and consequently the valve (1) is initially opened by the spring force which the compressed draft preventer (5) allows.

34. The device according to claim 20, wherein a bottom portion (13) is provided with two guide pins (40) in a width direction placed in a central position on an underside (54) of a bottom plate, one backward at a distance and an other almost along a front edge (31) on the covering portion (12) and in parallel with the longitudinal axis of the bearing pin (8), guide pins (40) are fitted into pre-bored holes in a surface, on which the valve (1) will be mounted, the guide pins secure the bearing pins (8) on the two corner portions (3), which retain the profile (4), reach a same mounting line at a same time, as the alignment guarantees, so that suitable friction, between the guide pins and the substantially round portion (9) of the profile (4), is obtained.
